(19) United States
(12) Patent Application Publication
(10) Pub. No.: US 2011/0208412 A1
(43) Pub. Date: Aug. 25, 2011

(54) ENGINE START CONTROL SYSTEM

(75) Inventor: Ryohei TAKAHASHI, Kariya-city (JP)

(73) Assignee: DENSO CORPORATION, Kariya-city (JP)

(21) Appl. No.: 13/032,841

(22) Filed: Feb. 23, 2011

(30) Foreign Application Priority Data
Feb. 24, 2010 (JP) 2010-39430

(51) Int. Cl. F02D 45/00

(52) U.S. Cl. 701/113

(57) ABSTRACT

A CPU confirms conditions of starter driving ports (output terminals of driver circuits) when the CPU returns from its reset condition, so as to determine an operational condition of a starter motor. When the CPU determines that the starter motor is maintained in a starter-ON condition by hardware latch circuits, the CPU changes an initialization process to an engine-start-up initialization process, according to which the starter-ON condition is continued. In the engine-start-up initialization process, the command signal from the CPU to the hardware latch circuits is initialized to the starter-ON command signal, and a software latch flag is set to an ON condition so that the operational condition of the starter motor before the reset of the CPU is determined.

### CROSS REFERENCE TO RELATED APPLICATION

This application is based on Japanese Patent Application No. 2010-039430 filed on Feb. 24, 2010, the disclosure of which is incorporated herein by reference.

### FIELD OF THE INVENTION

The present invention relates to an engine start control system, according to which ON-OFF operation of a starter motor for starting an engine is controlled by CPU.

### BACKGROUND OF THE INVENTION

According to one of known prior arts, for example, as disclosed in Japanese Patent Publication No. 2008-291763, a starter switch of a push-button type is provided in place of an ignition switch of a rotational operation type, wherein a signal of pushing operation for the push-button type switch is inputted to CPU, a command signal for turning on a starter motor is outputted from the CPU in order to crank an engine of a vehicle.

Since a large amount of electric current flows from a battery to the starter motor during the operation thereof, battery voltage is inevitably and temporarily decreased. The electric power is also supplied from the battery to the CPU, which controls the ON-OFF operation of the starter motor. Therefore, in a case that a charged amount in the battery has been decreased, the CPU may be reset if power supply voltage to the CPU is decreased to become lower than a voltage of a proper operation for the CPU during the operation of the starter motor.

When the power supply voltage to the CPU becomes lower than the voltage of the proper operation for the CPU during the operation of the starter motor, and thereby the CPU is reset, a predetermined initialization process is carried out when the CPU returns from the reset condition so that an ordinary process before the reset is again carried out. In the initialization process in case of the return of CPU from its reset condition, a starter command signal to be outputted from the CPU is initialized to a starter-OFF command signal, as in the same manner to an ordinary initialization process which is carried out when the power supply to the CPU is turned on. Therefore, when the CPU is reset during the operation of the starter motor, the starter motor is turned off by the initialization process at the return of the CPU from the reset condition. As a result, an engine may not be cranked up.

In order to solve such a problem, according to the above prior art (JP 2005-291763), another CPU (Power supply ECU) is provided in addition to the CPU (Engine ECU) for controlling the operation of the starter motor, wherein the voltage of the proper operation for the CPU (Power supply ECU) is lower than that for the CPU (Engine ECU). In the case that the CPU (Engine ECU) is reset during the operation of the starter motor, a starter relay is kept in an ON-condition for a certain period by the CPU (Power supply ECU), the voltage of the proper operation for which is lower than that for the CPU (Engine ECU). Accordingly, the engine is cranked up.

According to the above structure, however, it is necessary for two CPUs to work together in their control processes for controlling the operation of the starter motor (ON-OFF control of the starter motor). It is, therefore, a problem that the control processes may become complicated.

### SUMMARY OF THE INVENTION

The present invention is made in view of the above problems. It is an object of the present invention to provide an engine start control system, according to which an ON-condition of a starter motor can be maintained by a simple control process without using an additional CPU, when a CPU is reset during the operation of the starter motor. As result, an engine can be surely cranked up. Therefore, a problem that the engine may not be cranked up in case of the reset of the CPU can be improved in a low cost.

According to a feature of the present invention, for example, as defined in the appended claim 1, an engine start control system has a CPU for controlling ON-OFF operation of a starter motor to crank up an engine; and a holding circuit for keeping a starter-ON condition for a predetermined period, when the CPU is reset during an operation of the starter motor.

In the above engine start control system, when the CPU returns from its reset condition, the CPU confirms an operational condition of the starter motor at the reset of the CPU. In addition, when the CPU confirms that the operational condition of the starter motor at the reset of the CPU is in the starter-ON condition, the CPU carries out an engine-start-up initialization process, according to which the operational condition of the starter motor is maintained in the starter-ON condition.

According to the above feature, the starter-ON condition is maintained for a certain period by the holding circuit when the CPU is reset during the operation of the starter motor. In addition, the operational condition (ON or OFF condition) of the starter motor is confirmed at the return of the CPU from the reset condition. When the CPU confirms that the operational condition of the starter motor is in the starter-ON condition, the CPU carries out the engine-start-up initialization process, according to which the operational condition of the starter motor is maintained in the starter-ON condition. Accordingly, the starter-ON condition can be maintained by a simple structure (without using the additional CPU) and simple control process in order to surely start-up the engine, when the CPU is reset during the operation of the starter motor. As above, the problem that the engine may not be cranked up, which may be caused by the reset of the CPU 12, can be solved in a low cost.

According to another feature of the present invention, for example, as defined in the appended claim 2, when the CPU returns from its reset condition, the CPU confirms the operational condition of the starter motor at the reset of the CPU by checking a condition at an output side of the holding circuit. According to such a feature, it is possible to exactly determine the ON or Off condition of the starter motor at the return of the CPU from the reset condition.

According to a further feature of the present invention, for example, as defined in the appended claim 3, the engine-start-up initialization process includes; a first step, according to which a command signal outputted from the CPU to the holding circuit is initialized to a starter-ON command signal, and a second step, according to which a flag is set for indicating that the operational condition of the starter motor has been in the starter-ON condition before the reset of the CPU.

According to such a feature, it is prevented that the starter command signal maybe initialized to the starter-OFF command signal by the initialization process. Therefore, the starter motor is surely maintained in the ON condition even after the return of the CPU from the reset condition, to thereby start up the engine.

According to a still further feature of the present invention, for example, as defined in the appended claim 4, the CPU outputs a starter-OFF command signal, when the CPU detects that the engine has been cranked up during the operation of the starter motor or when a time period for the operation of the starter motor reaches at its maximum value for the starter-ON condition.

According to such a feature, a timing for turning off the starter motor is properly controlled by the CPU.

According to a still further feature of the present invention, for example, as defined in the appended claim 5, the engine start control system further has a starter switch of a push-button type for inputting a start-up signal to the CPU, wherein the CPU outputs the starter-ON command signal to the holding circuit, when the CPU receives the start-up signal from the starter switch, so that the starter motor is operated to crank up the engine.

According to such a feature, the problem that the engine of the vehicle having the push-button type starter switch may not be cranked up, which may be caused by the reset of the CPU, can be solved in a low cost.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram schematically showing an entire structure for an engine start control system for a vehicle according to an embodiment of the present invention;

FIG. 2 is a time chart for explaining a process when CPU is reset during an operation of a starter motor; and

FIG. 3 is a flowchart showing a process of an engine-start initialization process.

### DETAILED DESCRIPTION OF THE PREFERRED EMBODIMENTS

An embodiment of the present invention will be explained with reference to the drawings.

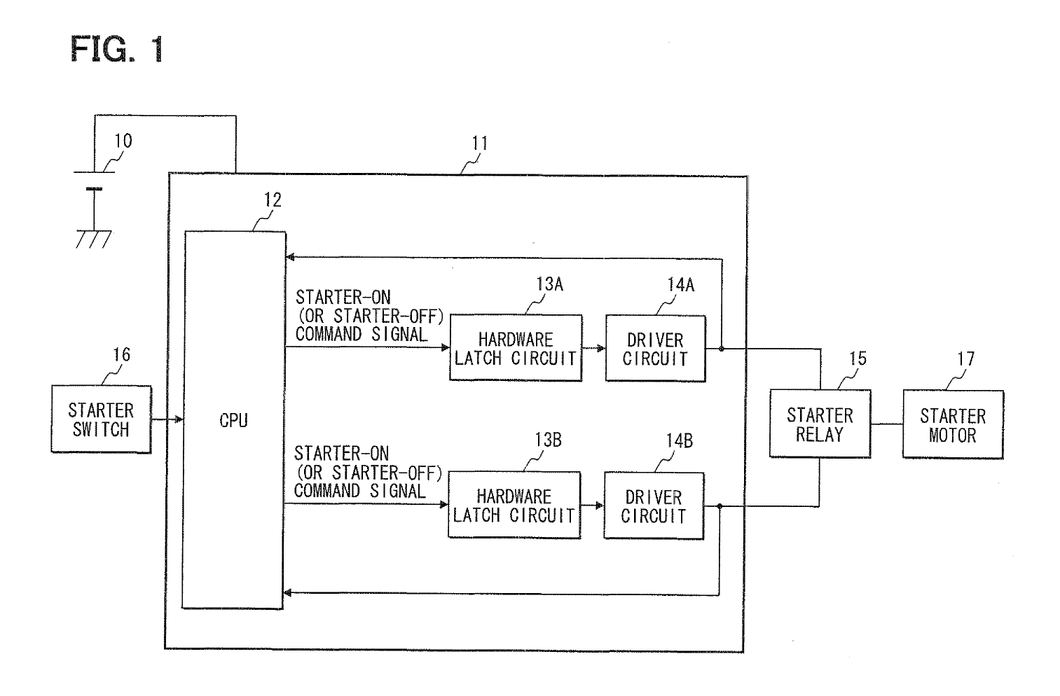

At first, a structure of an engine start control system will be explained with reference to FIG. 1.

The engine start control system is composed of an electronic control unit (ECU) 11, to which electric power voltage is supplied from a battery 10 mounted in a vehicle. The ECU 11 is composed of

CPU 12, ROM (not shown), RAM (not shown), hardware latch circuits (holding circuits) 13A and 13B, and driver circuits 14A and 14B for driving a starter relay 15. When the starter relay 15 is turned on, electric power is supplied to a starter motor 17 (a starter-ON condition), so that an engine of the vehicle is cranked up. When the starter relay 15 is turned off, the electric power supply to the starter motor 17 is stopped (a starter-OFF condition). A start-up signal is inputted to the CPU 12 from a starter switch 16 of a push-button type when it is operated.

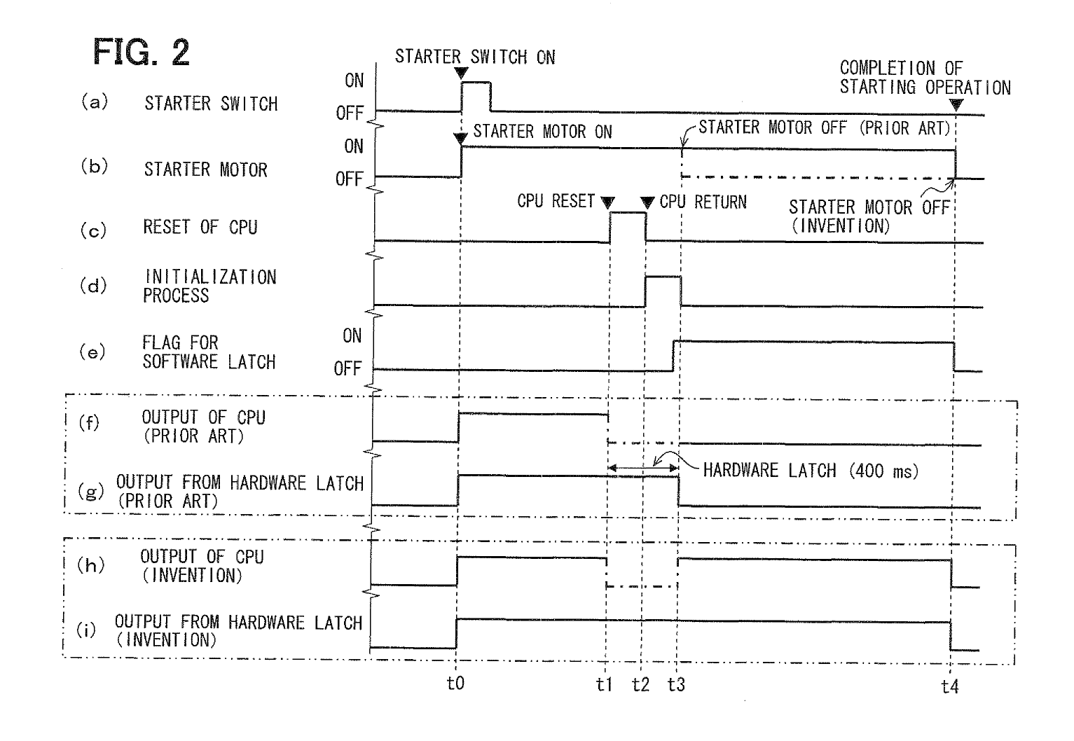

An operation of the engine start control system will be explained with reference to FIGS. 1 and 2. When a vehicle driver operates the starter switch 16 of the push-button type (at a timing t0 as shown in (a) of FIG. 2) so as to input the start-up signal to the CPU 12, a command signal for the starter-ON condition (a starter-ON command signal) is outputted from the CPU 12 to each of the hardware latch circuits 13A and 13B (as shown in (f) and (h) of FIG. 2). Then, an ON-signal (a high level signal) is respectively outputted from each of the hardware latch circuits 13A and 13B to each of the driver circuits 14A and 14B (as shown in (g) and (i) of FIG. 2). The starter relay 15 is thereby turned on (as shown in (b) of FIG. 2) to supply electric power to the starter motor 17. As a result, the engine is cranked up.

In the case that the ON-signals (the high level signals) are outputted from the hardware latch circuits 13A and 13B, and thereby the starter motor 17 is in its ON condition (namely, during the engine is being cranked up), the output signals (the high level signals) of the hardware latch circuits 13A and 13B are not immediately changed to low level signals (as shown in (g) and (i) of FIG. 2), even when the CPU 12 is reset (at a timing t1) due to a voltage decrease of the battery 10 and thereby the command signal for the starter-ON condition is no longer outputted from the CPU 12 (as shown by one-dot-chain lines between t1 and t3 in (f) and (h) of FIG. 2). In other words, during a predetermined time period (for example, 400 ms) from the reset of the CPU 12, the output signals of the hardware latch circuits 13A and 13B are kept at a condition of the ON-signal (the high level signals), so that the ON condition of the starter motor 17 is maintained for such predetermined period (for example, 400 ms).

The CPU 12 outputs a command signal for the starter-OFF condition (a starter-OFF command signal) to each of the hardware latch circuits 13A and 13B (as shown in (h) of FIG. 2), when the CPU 12 determines that a rotational speed of the engine exceeds a predetermined value for determining completion of engine crank-up during the starter motor operation and that the engine crank-up has been completed, or when a time period for the starter motor operation exceeds a maximum starter-ON time (for example, at a timing t4)

When the starter-OFF command signals are inputted to the respective hardware latch circuits 13A and 13B (at the timing t4), each of the hardware latch circuits 13A and 13B immediately reverses its output from the ON signal to an OFF signal (a low level signal). The starter relay 15 is thereby turned off to stop the electric power supply to the starter motor 17. As a result, the starter motor 17 is turned off.

When the power supply voltage is decreased to become lower than a voltage of a proper operation for the CPU 12 during the starter motor operation and thereby the CPU 12 is reset (as shown in (c) of FIG. 2, at the timing t1), a predetermined initialization process is carried out (as shown in (d) of FIG. 2, at the timings t2-t3) when the CPU 12 comes back from the reset condition to a normal operation condition (at the timing t2). As shown in (g) of FIG. 2, during the predetermined time period (for example, 400 ms) from the reset of the CPU 12, the output signals of the hardware latch circuits 13A and 13B are kept at the condition of the ON-signal (the high level signals), so that the ON condition of the starter motor 17 is maintained for the predetermined period (for example, 400 ms).

As shown in (f) and (g) of FIG. 2, according to a conventional system, the output signals from the CPU are initialized to the starter-OFF command signals in the initialization process (at the timings t2-t3 of (f) of FIG. 2) at a return of the CPU from the reset condition (at the timing t2), in the same manner to an initialization process carried out when the power supply to the CPU is turned on. In other words, the outputs of the CPU 12 are initialized to the low level signals at the timing t3. Therefore, when the CPU is reset during the starter motor operation, the starter motor is turned off after a hardware latch time (for example, 400 ms), at a timing t3 as shown in (g) of FIG. 2, due to the initialization process at the return of the CPU from the reset condition. Accordingly, the engine may not be cranked up.

On the other hand, according to the present embodiment, an initialization process for the engine crank-up (also referred to as an engine-start-up initialization process) is carried out in order to overcome the above problem. At first, when the CPU 12 is reset and returns from the reset condition, the CPU 12 determines whether the starter motor 17 is in an ON condition or in an OFF condition. And then, when the CPU 12 determines that the starter motor 17 is kept in the ON condition by the hardware latch circuits 13A and 13B, not the normal initialization process for the CPU 12 but the engine-start-up initialization process (as shown in (d) of FIG. 2) for the engine crank-up operation is carried out, so that the starter-ON condition is continued.

The engine-start-up initialization process includes the following processes:

a process for initializing the output signal (that is, the starter-ON or starter-OFF command signal) of the CPU 12 to the starter-ON command signal, which will be outputted to the hardware latch circuits 13A and 13B (as shown in (h) of FIG. 2, at the timing t3); and

a process for setting a software latch flag to an ON condition (as shown in (e) of FIG. 2), wherein the software latch flag is a flag for determining the operational condition of the starter motor 17 (that is, the starter-ON or starter-OFF condition) before the generation of the reset of the CPU 12. In other words, it is a process for setting a flag indicating that the starter motor 17 was in the ON condition even before the reset of the CPU 12.

According to the above process, it is avoided that the output signal of the CPU 12 is initialized to the starter-OFF command signal by the initialization process which is carried out at the return of the CPU 12 from the reset condition, and thereby the starter motor 17 is prevented from being turned off. Therefore, according to the present embodiment, it is possible to maintain the starter-ON condition even after the hardware latch time (for example, 400 ms) from the return of the CPU 12 from the reset condition (as shown in (i) of FIG. 2). As a result, the engine is surely cranked up.

Since the outputs of the CPU 12 are initialized to the starter-ON command signals at the timing t3, the starter-ON condition is maintained even at the timing t3 after the holding time (the hardware latch time, for example, 400 ms) of the hardware latch circuits 13A and 13B from the reset of the CPU 12 at the timing t1. When the CPU 12 confirms thereafter (at the timing t4) that the engine crank-up operation has been completed, the CPU 12 outputs the starter-OFF command signals to the hardware latch circuits 13A and 13B. When the starter-OFF command signals are inputted to the hardware latch circuits 13A and 13B, the hardware latch circuits 13A and 13B immediately output OFF signals (as shown in (i) of FIG. 2) to the driver circuits 14A and 14B. As a result, the operation of the starter motor 17 is terminated.

Now, a method for determining the operational condition of the starter motor 17 (that is, the starter-ON or starter-OFF condition) at the return of the CPU 12 from the reset condition (at the timing t2) will be explained. The operational condition of the starter motor 17 can be confirmed by checking electric current flowing through the starter motor 17 or through the starter relay 15. However, according to the present embodiment, the starter-ON or starter-OFF condition is determined by confirming the output side conditions of the hardware latch circuits 13A and 13B. The output side conditions of the hardware latch circuits 13A and 13B can be confirmed by detecting output voltages at output terminals of the hardware latch circuits 13A and 13B, or by detecting voltages at starter driving ports of the ECU 11 (at the output voltages at the driver circuits 14A and 14B).

As one of other alternative methods for determining the operational condition of the starter motor 17, the following method may be also possible. Namely, data of starter-ON or starter-OFF condition before the reset of the CPU 12 may be memorized in a rewritable and non-volatile memory device (for example, back-up RAM), and the data may be read out from the memory device at the return of the CPU 12 from the reset condition in order to confirm the starter-ON or starter-OFF condition. However, according to such a method, data at starting the starter motor in the past might have been memorized in the non-volatile memory, and thereby an erroneous determination for the starter-ON or starter-OFF condition may be done.

According to the present embodiment, however, the starter-ON or starter-OFF condition is determined by confirming the output side conditions of the hardware latch circuits 13A and 13B. Therefore, it is possible to exactly determine the starter-ON or starter-OFF condition at the return of the CPU 12 from the reset condition.

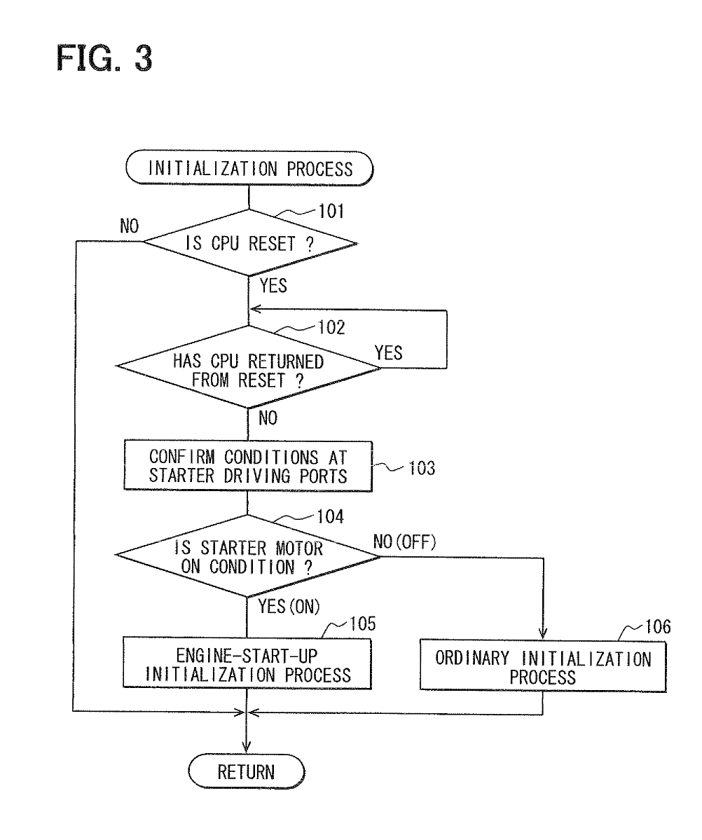

The above explained engine-start-up initialization process is carried out by the CPU 12 in accordance with a flowchart of FIG. 3. The process of FIG. 3 is repeatedly carried out in a predetermined cycle. When the process of FIG. 3 starts, the CPU 12 determines at a step 101 whether the CPU 12 is reset or not. And in case of NO, the process of FIG. 3 ends without carrying out the subsequent steps.

On the other hand, in case of YES at the step 101, namely when the CPU 12 determines at the step 101 that the CPU 12 is reset, the process goes to a step 102 and the process is held until the CPU 12 returns from the reset condition. When the CPU 12 has returned from the reset condition, the process goes to a step 103, at which the CPU 12 confirms conditions at the starter driving ports of the ECU 11 (that is, the output terminals of the driver circuits 14A and 14B). Then, the process goes to a step 104, at which the CPU 12 determines whether the starter motor is in the starter-ON condition or in the starter-OFF condition based on the condition at the starter driving ports of the ECU 11. When the CPU 12 determines at the step 104 that the starter motor 17 is in the starter-OFF condition, the process goes to a step 106, at which an ordinary initialization process is carried out. In this initialization process, the command signals from the CPU 12 to the hardware latch circuits 13A and 13B are initialized to the starter-OFF command signal, and also the software latch flag (for determining the operational condition of the starter motor 17 before the generation of the reset of the CPU 12) is initialized to an OFF condition. Then, the process of FIG. 3 ends.

When the CPU 12 determines at the step 104 that the starter motor 17 is in the starter-ON condition, the process goes to a step 105 at which the engine-start-up initialization process is carried out. In this initialization process, the command signals from the CPU 12 to the hardware latch circuits 13A and 138 are initialized to the starter-ON command signal, and also the software latch flag (for determining the operational condition of the starter motor 17 before the generation of the reset of the CPU 12) is initialized to the ON condition. Then, the process of FIG. 3 ends.

As a result of the above initialization process, the starter motor 17 is maintained in the starter-ON condition even after the hardware latch time (for example, 400 ms) from the return of the CPU 12 from the reset condition. The engine can be thereby surely cranked up.

According to the present embodiment, as explained above, the

CPU 12 confirms the starter-ON or starter-OFF condition, when the CPU 12 returns from the reset condition thereof, and the engine-start-up initialization process is carried out so that the starter-ON condition is continued when the CPU confirms that the starter motor was in the starter-ON condition before the generation of the reset of the CPU 12. Therefore, even when the CPU 12 is reset during the operation of the starter motor 17, the starter-ON condition can be continued by a simple control process without using an additional CPU (this is different from the prior art: JP 2008-291763), to thereby surely crank up the engine. As above, the problem that the engine may not be cranked up, which may be caused by the reset of the CPU 12, can be solved in a low cost.

According to the present embodiment, two systems for the hardware latch circuits 13A and 138 and the driver circuits 14A and 14B for driving the starter relay 15 are provided. However, one system or three systems for the hardware latch circuit(s) and the driver circuit(s) may be provided.

The present invention may not be limited to a manually operated starting system, but may be also applied to an engine automatic stop-and-start system (an idling-operation stop system). In this case, the CPU 12 may be reset when re-starting the engine during the idling-operation stopped condition. Then, the CPU 12 may confirm the starter-ON (or the starter-OFF) condition when the CPU returns from the reset condition, and the CPU 12 may carry out the engine-start-up initialization process when the CPU 12 confirmed that the starter motor was in the starter-ON condition before the reset of the CPU 12. As a result, the starter motor is continuously operated to surely crank up the engine.

The present invention may be modified in various ways without departing from the spirit of the invention. For example, a structure of the ECU 11 may be modified in a suitable manner.

What is claimed is:

1. An engine start control system comprising:
a CPU for controlling ON-OFF operation of a starter motor to crank up an engine; and
a holding circuit for keeping a starter-ON condition for a predetermined period, when the CPU is reset during an operation of the starter motor,
wherein, when the CPU returns from its reset condition, the CPU confirms an operational condition of the starter motor at the reset of the CPU, and
wherein, when the CPU confirms that the operational condition of the starter motor at the reset of the CPU is in the starter-ON condition, the CPU carries out an engine-start-up initialization process according to which the operational condition of the starter motor is maintained in the starter-ON condition.

2. The engine start control system according to the claim 1, wherein
when the CPU returns from its reset condition, the CPU confirms the operational condition of the starter motor at the reset of the CPU by checking a condition at an output side of the holding circuit.

3. The engine start control system according to the claim 1, wherein
the engine-start-up initialization process includes;
a first step, according to which a command signal outputted from the CPU to the holding circuit is initialized to a starter-ON command signal, and
a second step, according to which a flag is seₜ for indicating that the operational condition of the starter motor has been in the starter-ON condition before the reset of the CPU.

4. The engine start control system according to the claim 1, wherein
the CPU outputs a starter-OFF command signal, when the CPU detects that the engine has been cranked up during the operation of the starter motor or when a time period for the operation of the starter motor reaches at its maximum value for the starter-ON condition.

5. The engine start control system according to the claim 1, further comprising:
a starter switch of a push-button type for inputting a start-up signal to the CPU,
wherein the CPU outputs the starter-ON command signal to the holding circuit, when the CPU receives the start-up signal from the starter switch, so that the starter motor is operated to crank up the engine.
